(19) United States
(12) Patent Application Publication
(10) Pub. No.: US 2010/0185458 A1
(43) Pub. Date: Jul. 22, 2010

(54) Method for Retrieving Prescriptions with RFID Detection

(76) Inventors: David Newcomb, Raleigh, NC (US); David Alan Calderwood, Raleigh, NC (US); Thomas P. Rhoads, JR., Raleigh, NC (US)

Correspondence Address: MYERS BIGEL SIBLEY & SAJOVEC, PO BOX 37428, RALEIGH, NC, 27627, US

(21) Appl. No.: 12/688,206

(22) Filed: Jan. 15, 2010

Related U.S. Application Data
(60) Provisional application No. 61/146,395, filed on Jan. 22, 2009.

(51) Int. Cl. G06Q 10/00; G06F 17/00; G06Q 50/00; H04Q 5/22

(52) U.S. Cl. 705/2; 700/231; 700/216; 340/10.4

(57) ABSTRACT

A method of tracking the exit of a filled prescription from a storage area configured to house multiple filled prescriptions includes the steps of: providing a pharmaceutical vial filled with a prescription of a pharmaceutical for a particular patient, wherein the vial includes an RFID tag that is specific for the prescription; storing the pharmaceutical vial in the storage area; detecting the RFID tag with an RFID detector as the vial is stored in the storage area, the RFID detector being associated with a controller; removing the vial from the storage area; detecting the removal of the RIFD tag to indicate removal of the vial from the storage area; and recording the removal of the vial with the controller. T

### RELATED APPLICATION

The present application claims priority from U.S. Provisional Patent Application No. 61/146,395, filed Jan. 22, 2009, the disclosure of which is hereby incorporated herein in its entirety.

### BACKGROUND OF THE INVENTION

Pharmacy generally began with the compounding of medicines which entailed the actual mixing and preparing of medications. Heretofore, pharmacy has been, to a great extent, a profession of dispensing, that is, the pouring, counting, and labeling of a prescription, and subsequently transferring the dispensed medication to the patient. Because of the repetitiveness of many of the pharmacist's tasks, automation of these tasks has been desirable.

Some attempts have been made to automate the pharmacy environment. Different exemplary approaches are shown in U.S. Pat. No. 5,337,919 to Spaulding et al. and U.S Pat. Nos. 6,006,946; 6,036,812 and 6,176,392 to Williams et al. The Williams system conveys a bin with tablets to a counter and a vial to the counter. The counter dispenses tablets to the vial. Once the tablets have been dispensed, the system returns the bin to its original location and conveys the vial to an output device. Tablets may be counted and dispensed with any number of counting devices. Drawbacks to these systems typically include the relatively low speed at which prescriptions are filled and the absence in these systems of securing a closure (i.e., a lid) on the container after it is filled.

One additional automated system for dispensing pharmaceuticals is described in some detail in U.S. Pat. No. 6,971,541 to Williams et al. This system has the capacity to select an appropriate vial, label the vial, fill the vial with a desired quantity of a selected pharmaceutical tablet, apply a cap to the filled vial, and convey the labeled, filled, capped vial to an offloading station for retrieval. An updated version of the Williams system is described in U.S. Pat. No. 7,596,932 to Sink.

Some other systems are semi-automated, in that they may perform some of the tasks listed above, but rely on human intervention for others. For example, U.S. patent application Ser. No. 12/187,666, filed Aug. 7, 2008, discusses a system in which pharmaceutical tablets are automatically dispensed from a bin into a chute, where they remain until a technician releases them to fill a labeled vial. The vial is then manually capped and placed in an offload area for subsequent retrieval.

Although automated and semi-automated pharmaceutical dispensing systems can track prescriptions via a controller or the like during filling, each may benefit from additional systems that can track prescriptions once they exit the system.

### SUMMARY OF THE INVENTION

As a first aspect, embodiments of the present invention are directed to a method of tracking the exit of a filled prescription from a storage area configured to house multiple filled prescriptions. The method comprises the steps of: providing a pharmaceutical vial filled with a prescription of a pharmaceutical for a particular patient, wherein the vial includes an RFID tag that is specific for the prescription; storing the pharmaceutical vial in the storage area; detecting the RFID tag with an RFID detector as the vial is stored in the storage area, the RFID detector being associated with a controller; removing the vial from the storage area; detecting the removal of the RIFD tag to indicate removal of the vial from the storage area; and recording the removal of the vial with the controller. This method may eliminate the standard “scanning out” of vials typically used currently.

As a second aspect, embodiments of the present invention are directed to a method of returning a pharmaceutical prescription to stock, comprising the steps of: providing a plurality of stock bins, each of the stock bins including a bulk supply of a pharmaceutical; wherein at least some of the bins contain a different pharmaceutical than at least some of the other bins, providing a pharmaceutical vial filled with a prescription of a pharmaceutical for a particular patient, wherein the vial includes an RFID tag that is specific for the prescription; detecting the RFID tag with an RFID detector, the RFID detector being associated with a controller; responsive to the detecting of the RFID tag, determining the identity of the pharmaceutical contained in the vial; responsive to the detecting of the RFID tag, determining via the controller an identity of a first one of the stock bins, wherein the first stock bin contains the same pharmaceutical that is contained in the pharmaceutical vial; via the controller, automatically indicating the identity of the first stock bin; and emptying the pharmaceutical vial into the first stock bin. This method can facilitate and improve the “return to stock” process.

As a third aspect, embodiments of the present invention are directed to a method of dispensing a pharmaceutical prescription into a pharmaceutical vial, comprising the steps of: providing a plurality of stock bins, each of the stock bins including a bulk supply of a pharmaceutical, each of the stock bins including a dispensing outlet, wherein at least some of the bins contain a different pharmaceutical than at least some of the other bins, providing a pharmaceutical vial to be filled with a prescription of a pharmaceutical for a particular patient, wherein the vial includes an RFID tag that is specific for the prescription; providing a controller associated with the plurality of stock bins, the controller including data regarding a sequence in which a plurality of prescriptions are to be filled; detecting the RFID tag with an RFID detector, the RFID detector being associated with a controller; incorporating the detected prescription into the sequence of prescriptions in the controller; via the controller, signaling a first one of the stock bins to dispense pharmaceuticals into the vial, wherein the first stock bin contains the pharmaceutical associated with the prescription; and automatically dispensing the pharmaceutical from the first stock bin into its associated dispensing outlet. This method can enable the reprioritization of a dispensing sequence, particularly for semi-automated pharmacy dispensing systems.

As a fourth aspect, embodiments of the present invention are directed to a method dispensing a pharmaceutical prescription into a pharmaceutical vial, comprising the steps of: providing a plurality of stock bins, each of the stock bins including a bulk supply of a pharmaceutical, each of the stock bins including a dispensing outlet, wherein at least some of the bins contain a different pharmaceutical than at least some of the other bins; providing a pharmaceutical vial to be filled with a prescription of a pharmaceutical for a particular patient, wherein the vial includes an RFID tag that is specific for the prescription; detecting the RFID tag with an RFID detector, the RFID detector being associated with a controller; automatically dispensing the pharmaceutical from a first stock bin into its associated dispensing outlet; via the controller, signaling that the dispensing outlet associated with the first stock bin contains the pharmaceutical to be used to fill the prescription; and dispensing the pharmaceutical from the dispensing outlet into the vial. This method can improve the accuracy of dispensing, particularly for semi-automated pharmacy dispensing systems.

### BRIEF DESCRIPTION OF THE FIGURES

FIG. 1 is a perspective view of an automated pharmacy dispensing system that can be employed with embodiments of the present invention.

FIG. 2 is a schematic top view of the system of FIG. 1 with a sensing zone.

FIG. 3 is a flow chart illustrating methods according to embodiments of the present invention.

FIG. 4 is a flow chart illustrating methods according to additional embodiments of the present invention.

FIG. 5 is a perspective view of a semi-automated pharmaceutical dispensing system that can be used with embodiments of the present invention.

FIG. 6 is a flow chart illustrating methods according to further embodiments of the present invention.

FIG. 7 is a flow chart illustrating methods according to still further embodiments of the present invention.

### DETAILED DESCRIPTION OF EMBODIMENTS OF THE INVENTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity. Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein the expression “and/or” includes any and all combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Where used, the terms “attached”, “connected”, “interconnected”, “contacting”, “mounted,” “coupled” and the like can mean either direct or indirect attachment or contact between elements, unless stated otherwise. In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Embodiments of the invention are directed to methods of tracking prescriptions filled with automated and semi-automated prescription dispensing systems. In either instance, RFID tags and detectors can be included in the unit to uniquely identify each prescription. That information can then be employed in different tracking tasks, as described below.

As used herein, an “RFID tag” is an object applied to or incorporated into a component for the purpose of identification and tracking using radio waves. Some RFID tags can be read from several meters away and beyond the line of sight of the reader. Many RFID tags contain at least two parts. One is an integrated circuit for storing and processing information, modulating and demodulating a radio-frequency (RF) signal, and other specialized functions. The second is an antenna for receiving and transmitting the signal. There are generally three types of RFID tags: active RFID tags, which contain a battery and can transmit signals autonomously, passive RFID tags, which have no battery and require an external source to provoke signal transmission, and battery assisted passive (BAP) which require an external source to wake up but have significant higher forward link capability providing great read range. Any of these may be used in connection with the present invention.

In embodiments of the present invention, RFID tags may be embedded in or attached to a vial, label, or cap to identify each prescription. An RFID detector may be positioned anywhere on or near the pharmaceutical dispensing system or offload area to identify or track a prescription. The RFID detector is typically in communication with, either directly or wirelessly, a controller that controls the operation of the dispensing system. Such controllers are discussed, for example, in U.S. Pat. No. 7,596,932, supra, the disclosure of which is hereby incorporated herein by reference.

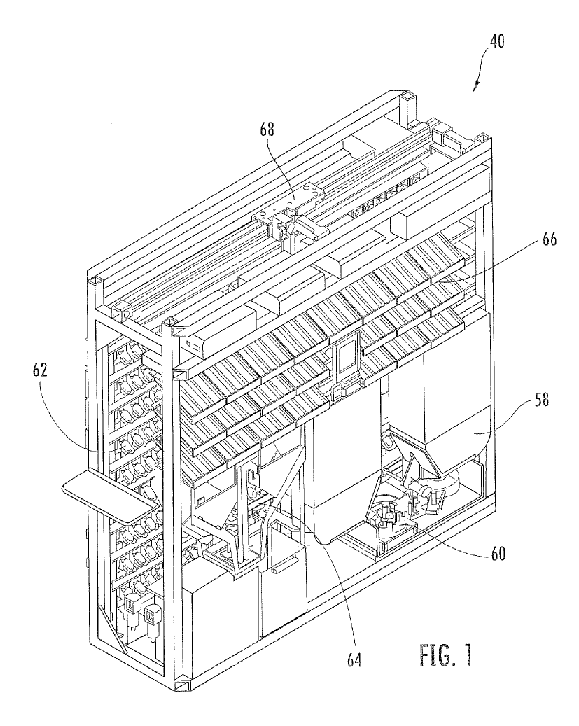

By using RFID sensing in the direct vicinity of an automated dispensing system, the system can automatically detect when a particular prescription is removed from the system and it can provide notification to other devices of the removal event. For example, automated filling systems typically use a drop-off or prescription retrieval area for filled prescriptions that have been completed. As an example, FIG. 1 illustrates a an automated pharmacy dispensing system 40, which includes generally a vial dispensing station 58, a vial labeling station 60, stock bins 62, at least some of which contain different pharmaceuticals for dispensing than some of the other bins 62, a capping station 64, and an offload/storage area 66. A robotic arm 68 moves vials to different stations within the system 40. These components are discussed in, for example, U.S. Pat. No. 7,596,932 and U.S. Patent Publication No. 2008/0283544, the disclosure of each of which is hereby incorporated herein in its entirety.

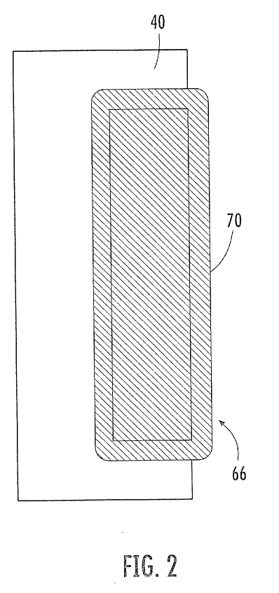

As illustrated schematically in FIG. 2, a RFID sensing zone 70 with an RFID detector can be created in the vicinity of the offload/storage area 66. The offload/storage area 66 is illustrated as having a number of different sections; a different sensing zone 70 (and RFID detector) may be confined to each individual drop-off section, or the sensing zone 70 may encompass the entire offload/storage area 66.

The detector of the sensing zone 70 is in communication with the controller 200 (either wirelessly or in a hard-wired fashion), and can signal the presence of an RFID tag in the sensing zone 70, thereby enabling the controller 200 to track the tag (and, in turn, the vial to which it is attached). In some embodiments, the sensing zone 70 may be located and configured such that it substantially continuously detects the presence of an RFID tag in the sensing zone 70, and the absence of the RFID signal from the tag indicates that the vial has been removed from the offload/storage area 66. In other embodiments, the sensing zone 70 may be configured so that it does not sense RFID signals from vials in the offload/storage area 66, but that vials being removed from the offload/storage area 66 must pass through the sensing zone 70, such that the detection of an RFID tag by the sensing zone 70 indicates to the controller 200 that the vial has been removed from the offload/storage area 66.

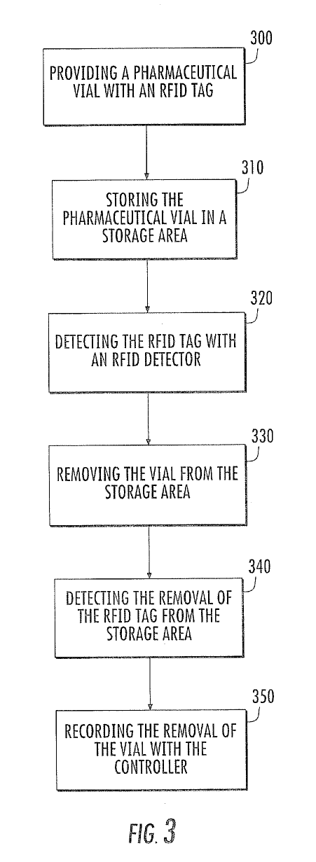

The technique is illustrated in FIG. 3. Initially, a vial is provided with an RFID tag (Block 300) and, once the vial is filled with a prescription for a particular patient, stored in a storage area (Block 310). The RFID tag is specific for the prescription. The RFID tag is detected with an RFID detector associated with a controller (Block 320). The vial is removed from the storage area (Block 330), and the removal of the RFID tag is detected (Block 340). The removal of the vial and tag is then recorded in the controller (Block 350). The process can then be repeated for subsequent prescriptions.

This technique may be highly useful for scan out verification in an automated system. Using RFID as a means of tracking if a prescription has been removed from the automated system can replace the need for manually scanning out a vial when the prescription is retrieved.

Furthermore, by using this RFID tracking technique, the system can notify other devices or software that a prescription was removed from the system. Upon querying the automated system, the system can provide accurate status on what stage of the filling process the prescription has completed, including whether or not the prescription has been removed. Up until now, automated filling systems were typically reliant upon a manual scan-out process for vial retrieval. Now, the complete tracking of a prescription can be fully automated increasing the accuracy of the tracking status.

Potentially, the manual process of scanning out of a prescription can be eliminated by using the RFID tracking method. The vial can be removed from the automated system and the removal can be detected automatically. This may provide a productivity enhancement.

Also, through using this RFID technique with a different sensing area, the return to stock process can be simplified as well. Details of the return to stock process are described in U.S. Pat. No. 7,263,411 to Shows et al., the disclosure of which is hereby incorporated herein in its entirety. For example, a technician may approach the individual cells that hold pharmaceuticals to return a prescription to stock, (e.g., if it was not picked up by the patient or customer), where a nearby sensing zone is located. Software may automatically obtain the information without a scan and prompt the user to verify the intention to return the medication to dispenser stock. Upon verification that the user intends to return to the prescription to stock, the system may automatically indicate where the cell is and unlock the stock bin for the return to stock.

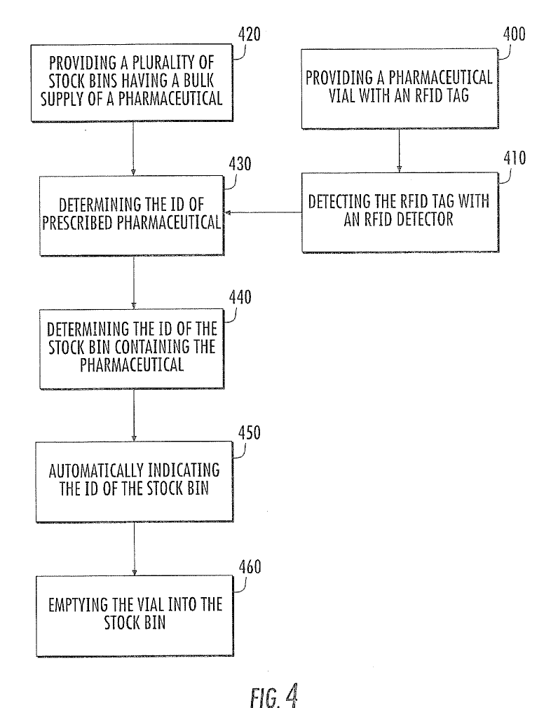

This process is illustrated in FIG. 4. A vial filled with a prescription for a particular patient and having an RFID tag is provided (Block 400). The RFID tag is detected with an RFID detector (Block 410). A plurality of stock bins is also provided (Block 420). Detection of the RFID tag enables a controller to determine the identity of the pharmaceutical in the vial (Block 430) and the identity of the stock bin containing that pharmaceutical (Block 440). The controller then automatically indicates (via an indicator light, a buzzer, a screen display, or the like) the identity of the correct stock bin (Block 450), at which point the technician can open the bin and return the pharmaceutical to stock (Block 460). In some embodiments, the stock bin may have a lockable replenishment door that is unlocked when the controller determines the identity of the correct bin. This process can be repeated for additional prescriptions.

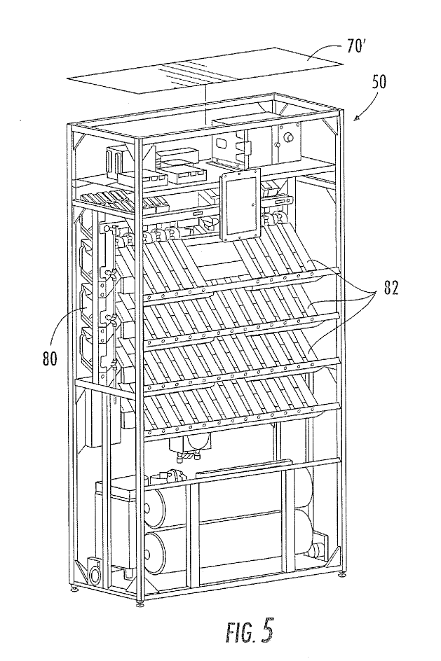

An RFID sensing zone can be used in semi-automated systems to fill on demand. Such a semi-automated system, designated broadly at 50, is illustrated in FIG. 5 and discussed in U.S. patent application Ser. No. 12/187,666, supra. The system includes a plurality of stock bins 80, each attached to a dispensing outlet in the form of a chute 82. When the system 50 receives an instruction to dispense a pharmaceutical, the proper bin 80 dispenses the pharmaceutical into its respective chute 82, where it is captured. A technician can then dispense the pharmaceutical from the chute 82 into a vial, after which the vial is capped and offloaded. Such a system will typically have a dispensing sequence, controlled by data stored in the controller, that determines the order in which prescriptions are dispensed from the bins 80 into their respective chutes 82.

It is contemplated that the system 50 may include a sensing zone 70′ (for example, in the vicinity of the outlets of the chutes 82). When a vial with an RFID tag enters the sensing zone 70′, the semi-automated system 50 can move that prescription up in the sequence or queue to be dispensed immediately before other prescriptions that might be waiting to be filled (i.e., it may be moved to the first spot in the sequence), or to another reprioritized spot in the sequence.

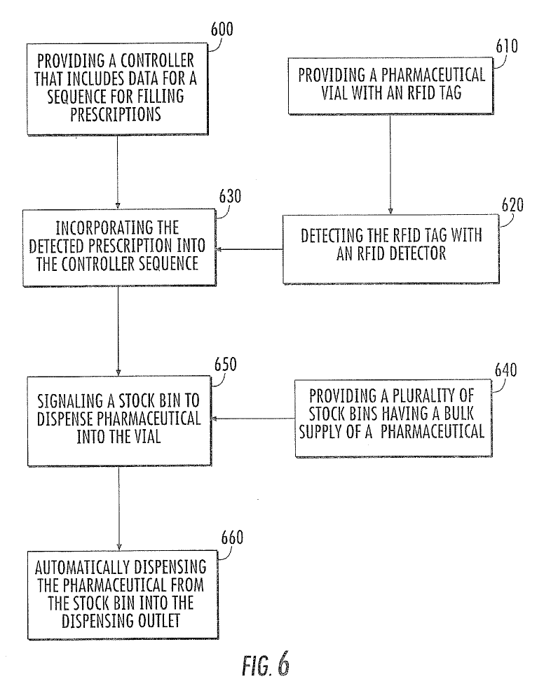

This process, illustrated in FIG. 6, begins with the provision of a controller that includes data for a sequence for filling prescriptions (Block 600). A pharmaceutical vial with an RFID tag is provided (Block 610), and the tag is detected by an RFID detector (Block 620). The detected prescription is incorporated into the sequence of prescriptions stored in the controller (Block 630). From a plurality of stock bins (Block 640), the controller signals one of the stock bins to dispense a pharmaceutical associated with the prescription into its dispensing outlet (Block 650), which is then automatically carried out (Block 660). The prescription can subsequently be dispensed (typically manually) from the dispensing outlet into the vial. The process can be repeated for other prescriptions using another vial and another pharmaceutical.

The RFID sensing zone 70′ can also be used in the semi-automated system 50 to verify the correctness of a prescription. For example, when a vial with an RFID tag enters the sensing zone 70′, the system 50 can alert the user if the wrong dispensing chute 82 was opened or can provide a notification to the user of the proper dispensing chute 82 to be used to dispense the correct medication into the tagged vial. For systems with locking chutes, only the correct chute would be unlocked for dispensing.

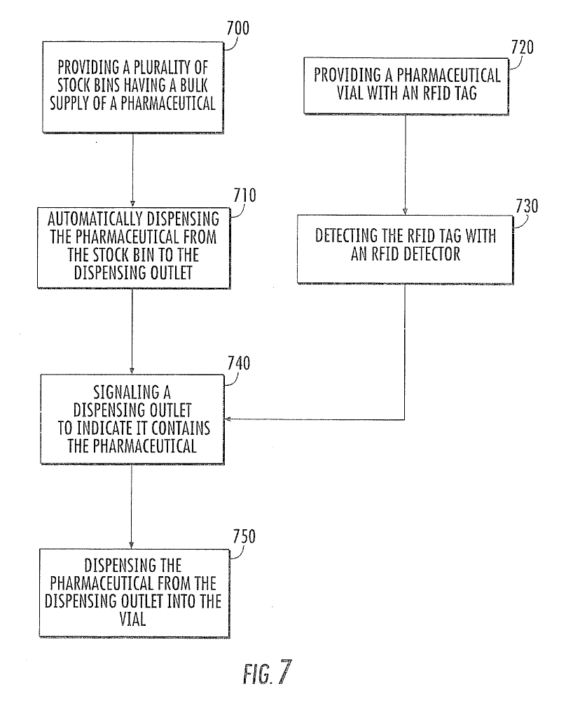

This process is illustrated in FIG. 7. From a plurality of stock bins (Block 700), a controller signals one of the bins to dispense a pharmaceutical into its dispensing outlet (Block 710). A vial with an RFID tag is provided (Block 720) and detected (Block 730). The controller responds to the RFID detection by indicating which dispensing outlet contains the correct pharmaceutical (Block 740) (again, with an indicator light, a buzzer, a screen display, or the like). The pharmaceutical is then dispensed (often manually) into the vial (Block 750). The controller may also unlock the dispensing outlet if it is lockable (see, e.g., U.S patent application Ser. No. 12/186,025, the disclosure of which is hereby incorporated herein in its entirety).

Finally, an RFID sensing area on the offloading zones could be used to identify which individual picked up which vial by having users wear individual RFID tags. The system could alert and even take a picture of an unauthorized retrieval.

Current state of the art uses a manual process of barcode scan out for prescription retrieval. Some units limit the offload sections' capability to one prescription and use a sensor per section. The above technique of RFID tracking can automate the process of prescription retrieval without limiting the offload section to one prescription. Furthermore, the technique can provide a higher level of confidence that a particular prescription has been removed from the system. Finally, the technique differs from the state of the art in that it can detect whether or not a specific prescription was placed back into the offload section after an initial retrieval.

Systems that dispense finished prescriptions either directly to customers or as will call systems within pharmacies, such as, for example, those disclosed in U.S. Pat. No. 7,228,200 to Baker et al, U.S. Pat. No. 7,410,098 to Denenberg et al., and pending U.S. patent application Nos. 11/648,153 and 12/502,542, the disclosures of which are hereby incorporated herein in their entirety, may also benefit from the inventions disclosed herein. Such systems store finished prescriptions until their retrieval by a customer or pharmacy worker and must store and manage information about each prescription such as information identifying the prescription or customer, as well as its storage location within the system. Other information that may be monitored by the system includes date of entry of the prescription into the system, expiration date of the pharmaceutical, payment status, identity of individuals authorized to retrieve the prescription, etc. Inclusion of a RFID tag on or in the vial or label can allow automatic entry of such information into the system as the prescription is placed in the system, as well as monitoring and logging of removal of the prescription from the system.

The foregoing embodiments are illustrative of the present invention, and are not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A method of tracking the exit of a filled prescription from a storage area configured to house multiple filled prescriptions, comprising the steps of:
providing a pharmaceutical vial filled with a prescription of a pharmaceutical for a particular patient, wherein the vial includes an RFID tag that is specific for the prescription;
storing the pharmaceutical vial in the storage area;
detecting the RFID tag with an RFID detector as the vial is stored in the storage area, the RFID detector being associated with controller;
removing the vial from the storage area; and
detecting the removal of the RIFD tag to indicate removal of the vial from the storage area; and
recording the removal of the vial with the controller.

2. The method defined in claim 1, wherein the step of detecting the removal of the RFID tag comprises detecting the absence of the RFID tag from the storage area.

3. The method defined in claim 1, wherein the step of detecting the removal of the RFID tag comprises detecting the RFID tag as it passes through a detecting zone that is separate from the storage area.

4. The method defined in claim 1, further comprising the steps of:
providing a second pharmaceutical vial filled with a prescription of a pharmaceutical for a particular patient, wherein the vial includes a second RFID tag that is specific for the prescription;
storing the second pharmaceutical vial in the storage area;
detecting the second RFID tag with the RFID detector as the second vial is stored in the storage area;
removing the second vial from the storage area; and
detecting the removal of the second RIFD tag to indicate removal of the second vial from the storage area; and
recording the removal of the second vial with the controller.

5. The method defined in claim 1, wherein the storage area is located within an automated pharmacy dispensing machine.

6. The method defined in claim 5, further comprising the steps of:
automatically filling the prescription with the automated pharmacy dispensing machine; and
automatically offloading the filled prescription to the storage area with the automated pharmacy machine.

7. A method of returning a pharmaceutical prescription to stock, comprising the steps of:
providing a plurality of stock bins, each of the stock bins including a bulk supply of a pharmaceutical; wherein at least some of the bins contain a different pharmaceutical than at least some of the other bins,
providing a pharmaceutical vial filled with a prescription of a pharmaceutical for a particular patient, wherein the vial includes an RFID tag that is specific for the prescription;
detecting the RFID tag with an RFID detector, the RFID detector being associated with a controller;
responsive to the detecting of the RFID tag, determining the identity of the pharmaceutical contained in the vial;
responsive to the detecting of the RFID tag, determining via the controller an identity of a first one of the stock bins, wherein the first stock bin contains the same pharmaceutical that is contained in the pharmaceutical vial;
via the controller, automatically indicating the identity of the first stock bin; and
emptying the pharmaceutical vial into the first stock bin.

8. The method defined in claim 7, wherein the step of indicating the identity of the first stock bin comprises illuminating a signal light corresponding to the first bin.

9. The method defined in claim 7, wherein each of the stock bins includes a lockable replenishment door, and further comprising automatically unlocking the door of the first bin responsive to the determining step.

10. The method defined in claim 7, wherein the plurality of stock bins is mounted in an automated pharmacy dispensing machine.

11. The method defined in claim 7, further comprising the steps of:
providing a second pharmaceutical vial filled with a second prescription of a pharmaceutical for a particular patient, wherein the vial includes a second RFID tag that is specific for the second prescription;
detecting the second RFID tag with the RFID detector, the RFID detector being associated with a controller;
responsive to the detecting of the RFID tag, determining the identity of the second pharmaceutical contained in the second vial;
responsive to the detecting of the second RFID tag; determining via the controller an identity of a second one of the stock bins, wherein the second stock bin contains the same pharmaceutical contained in the second pharmaceutical vial;
via the controller, automatically indicating the identity of the second stock bin; and
emptying the second pharmaceutical vial into the second stock container.

12. A method of dispensing a pharmaceutical prescription into a pharmaceutical vial, comprising the steps of:
providing a plurality of stock bins, each of the stock bins including a bulk supply of a pharmaceutical, each of the stock bins including a dispensing outlet, wherein at least some of the bins contain a different pharmaceutical than at least some of the other bins,
providing a pharmaceutical vial to be filled with a prescription of a pharmaceutical for a particular patient, wherein the vial includes an RFID tag that is specific for the prescription;
providing a controller associated with the plurality of stock bins, the controller including data regarding a sequence in which a plurality of prescriptions are to be filled;
detecting the RFID tag with an RFID detector, the RFID detector being associated with a controller;
incorporating the detected prescription into the sequence of prescriptions in the controller;
via the controller, signaling a first one of the stock bins to dispense pharmaceuticals, wherein the first stock bin contains the pharmaceutical associated with the prescription; and
automatically dispensing the pharmaceutical from the first stock bin into its associated dispensing outlet.

13. The method defined in claim 12, further comprising the step of reprioritizing the sequence based on the detecting step.

14. The method defined in claim 13, wherein the reprioritizing step comprises moving the detected prescription to the first spot in the sequence.

15. The method defined in claim 12, wherein the dispensing step further includes dispensing the pharmaceutical from the associated dispensing outlet into the vial.

16. The method defined in claim 14, wherein the step of dispensing the pharmaceutical from the associated dispensing outlet into the vial is performed manually.

17. The method defined in claim 12, further comprising the steps of:
providing a second pharmaceutical vial to be filled with a second prescription of a pharmaceutical for a particular patient, wherein the second vial includes a second RFID tag that is specific for the second prescription;
detecting the second RFID tag with the RFID detector, the RFID detector being associated with a controller;
via the controller, signaling a second one of the stock bins to dispense pharmaceuticals, wherein the second stock bin contains the pharmaceutical associated with the second prescription; and
automatically dispensing the pharmaceutical from the second stock bin into its associated dispensing outlet.

18. A method of dispensing a pharmaceutical prescription into a pharmaceutical vial, comprising the steps of:
providing a plurality of stock bins, each of the stock bins including a bulk supply of a pharmaceutical, each of the stock bins including a dispensing outlet, wherein at least some of the bins contain a different pharmaceutical than at least some of the other bins;
providing a pharmaceutical vial to be filled with a prescription of a pharmaceutical for a particular patient, wherein the vial includes an RFID tag that is specific for the prescription;
detecting the RFID tag with an RFID detector, the RFID detector being associated with a controller;
automatically dispensing the pharmaceutical from a first stock bin into its associated dispensing outlet;
via the controller, signaling that the dispensing outlet associated with the first stock bin contains the pharmaceutical to be used to fill the prescription; and
dispensing the pharmaceutical from the dispensing outlet into the vial.

19. The method defined in claim 18, wherein the dispensing outlet is lockable, and wherein the signaling step unlocks the dispensing outlet.

20. The method defined in claim 19, wherein the step of dispensing the pharmaceutical from the dispensing outlet into the vial is performed manually.
